(19) United States
(12) Patent Application Publication
(10) Pub. No.: US 2016/0134015 A1
(43) Pub. Date: May 12, 2016

(54) ANTENNA DIRECTIVITY CONTROL SYSTEM

(71) Applicant: Asahi Glass Company, Limited, Chiyoda-ku (JP)

(72) Inventors: Ryuta SONODA, Chiyoda-ku (JP); Koji IKAWA, Chiyoda-ku (JP); Kotaro SUENAGA, Chiyoda-ku (JP); Toshiki SAYAMA, Chiyoda-ku (JP)

(73) Assignee: Asahi Glass Company, Limited, Chiyoda-ku (JP)

(21) Appl. No.: 14/995,474

(22) Filed: Jan. 14, 2016

Related U.S. Application Data
(63) Continuation of application No. PCT/JP2014/072498, filed on Aug. 27, 2014.

(30) Foreign Application Priority Data
Aug. 29, 2013 (JP) 2013-178670

(51) Int. Cl. H01Q 3/26; H01Q 1/12

(52) U.S. Cl. CPC H01Q 3/2611; H01Q 1/1257

(57) ABSTRACT

Disclosed is an antenna directivity control system including variable directivity antennas; a measurement unit to measure received signal quality and channel quality of a received signal of the antennas; a selection unit to select, in response to a measured value of the received signal quality and a measured value of the channel quality, a directivity pattern that is to be set for the antennas from directivity pattern candidates that are prepared in advance; and a setting unit to set the selected directivity pattern for the antennas.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2014/072498 filed on Aug. 27, 2014 and designating the U.S., which claims priority of Japanese Patent Application No. 2013-178670 filed on Aug. 29, 2013. The entire contents of the foregoing applications are incorporated herein by reference.

### BACKGROUND OF THE INVENTION

1. Field of the Invention

The present invention relates to an antenna directivity control system.

2. Description of the Related Art

As a method for enhancing communication speed, a multiple-input multiple-output (MIMO) spatial multiplexing communication technique by using multiple antennas has been utilized. However, in mobile communication, a radio wave propagation environment for a terminal can be diverse, and in fact, an environment where MIMO spatial multiplexing communication can be utilized can be limited.

For example, Non-Patent Document 1 discloses actually measured data of an angle spread of incoming radio waves in an urban area. It shows that, even in an urban area where there are relatively many reflection objects, an angle spread of incoming radio waves may be less than or equal to 30 degrees, so that a sufficiently rich multi-paths environment may not be obtained.

Due to such a fact, in the 3GPP standard that is Non-Patent Document 2, in addition to the MIMO spatial multiplexing mode, nine transmission modes, such as a beam forming mode, a transmit diversity mode, and a multi-user MIMO mode, are specified in total. A method has been adopted such that a radio wave environment where a terminal is located is measured based on a reference signal that is transmitted from a base station, and a proper transmission mode is selected.

Whereas, as a means for enhancing communication performance, multi-antennas having a variable directivity function have been studied. With regard to such a variable directivity antenna, in Patent Document 1, a directivity selection means for a variable directivity antenna is disclosed as a means for enhancing robustness against variation in a radio wave environment in the MIMO spatial multiplexing communication.

### PRIOR ART DOCUMENTS

### [Patent Documents]

Patent Document 1: Japanese Unexamined Patent Publication No. 2010-258579

### [Non-Patent Documents]

Non-Patent Document 1: Tetsuro Imai, etc., “A Propagation Prediction System for Urban Area Macrocells Using Ray-tracing Methods,” NTT DoCoMo Technical Journal, Vol. 6, No. 1, p. 41-51

Non-Patent Document 2: 3GPP TS 36.213 V10.1.0 3rd Generation Partnership Project; Technical Specification Group Radio Access Network; Evolved Universal Terrestrial Radio Access(E-UTRA); Physical layer procedures (Release 10), p. 26-27

Non-Patent Document 3: Taga, “Analysis for Correlation Characteristics of Antenna Diversity in Land Mobile Radio Environments,” Institute of Electronics, Information and Communication Engineers B-II, Vol. J-73-B-II, No. 12, p. 883-895

Non-Patent Document 4: Karasawa, “MIMO Propagation Channel Modeling,” Institute of Electronics, Information and Communication Engineers B, Vol. J-86-B, No. 9, p. 1706-1720

### SUMMARY OF THE INVENTION

However, the method that is disclosed in Patent Document 1 is a technique that considers correlation between directivity patterns, and its prerequisite is to only select an antenna configuration such that correlation between antennas is low. Consequently, it can be utilized for MIMO spatial multiplexing communication; however, a favorable communication performance may not be achieved, if a transmission mode other than the MIMO spatial multiplexing communication is selected, as described above.

Thus, an object of the present invention is to provide an antenna directivity control system that follows variations in a radio wave propagation environment to select a proper directivity pattern.

According to an aspect of the present invention, there is provided an antenna directivity control system including variable directivity antennas; a measurement unit to measure received signal quality and channel quality of a received signal of the antennas; a selection unit to select, in response to a measured value of the received signal quality and a measured value of the channel quality, a directivity pattern that is to be set for the antennas from directivity pattern candidates that are prepared in advance; and a setting unit to set the selected directivity pattern for the antennas.

According to an embodiment, a proper directivity pattern can be selected by following variations in a radio wave propagation environment.

### BRIEF DESCRIPTION OF THE DRAWINGS

FIG. 1 is a block diagram showing a configuration example of a directivity control system;

FIG. 2 is a graph showing comparative data of channel capacity for a case where an angle spread of an incoming radio wave is 100 degrees;

FIG. 3 is a graph showing comparative data of channel capacity for a case where an angle spread of an incoming radio wave is 10 degrees;

FIG. 4 is a graph showing comparative data of channel capacity for a BF mode;

FIG. 5 is a pattern diagram showing examples of shapes of directivity model patterns for creating directivity pattern candidates that are prepared in advance;

FIG. 6 is a pattern diagram showing examples of shapes of directivity model patterns for creating directivity pattern candidates that are prepared in advance;

FIG. 7 is a flowchart showing an example of a method of selecting a directivity pattern;

FIG. 8 is a pattern diagram showing examples of shapes of directivity patterns for creating directivity pattern candidates;

FIG. 9 is a graph set showing an example of analyzed data of the channel capacity with respect to a SINR for a case where transmissions are executed in a MIMO mode for five types of angle spreads σp, based on measured data of four types of directivity patterns for which correlation coefficients between antennas are different from each other;

FIG. 10 is a graph set showing an example of analyzed data of the channel capacity with respect to the SINR for a case where transmissions are executed in the BF mode for the five types of angle spreads σp, based on the measured data of the four types of directivity patterns for which the correlation coefficients between the antennas are different from each other; and

FIG. 11 is a graph set showing an example of analyzed data between the SINR and the channel capacity for cases where transmissions are executed by the MIMO mode and the BF mode.

### DESCRIPTION OF THE PREFERRED EMBODIMENTS

<Configuration of Antenna Directivity Control System>

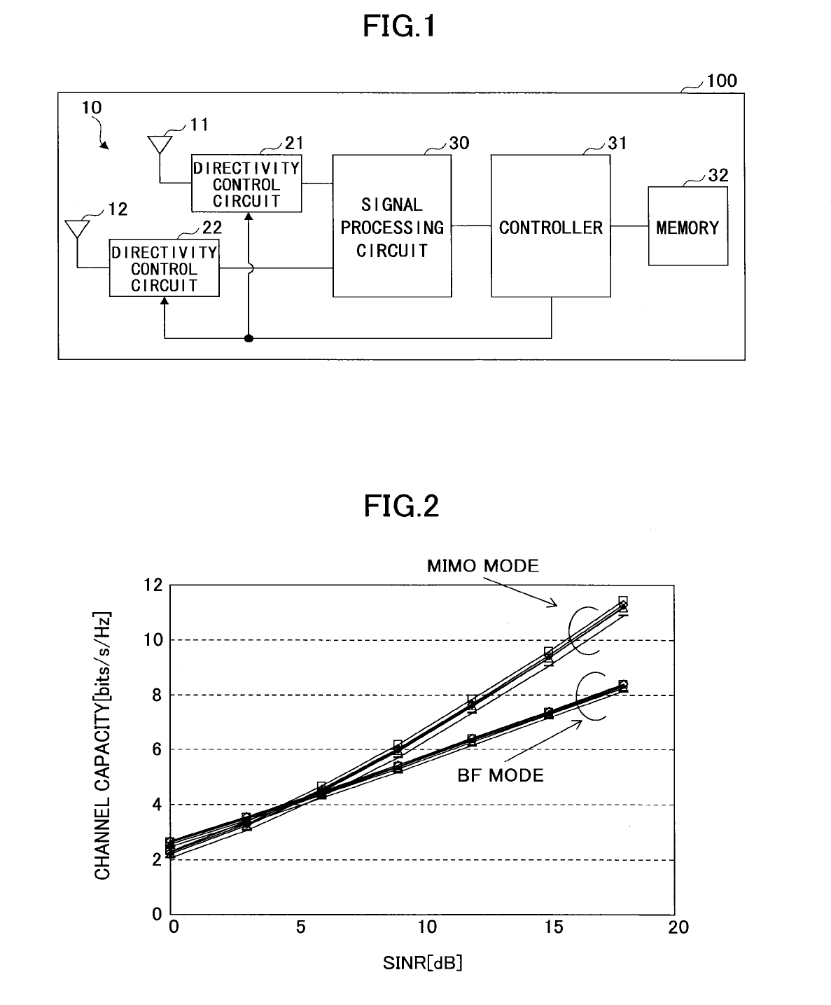

FIG. 1 is a block diagram showing a configuration example of an antenna directivity control system 10 according to an embodiment of the present invention. The antenna directivity control system 10 is an antenna system that is to be installed in a radio communication device 100, for example. As an example of the radio communication device 100, there is a mobile entity itself or a communication device that is installed inside the mobile entity. As examples of the mobile entity, there are a portable mobile terminal device; a vehicle, such as an automobile; a robot; and so forth. As specific examples of the mobile terminal device, there are electronic devices, such as a cellular phone, a smartphone, a tablet type computer, and so forth.

The antenna directivity control system 10 includes a plurality of variable directivity antennas 11 and 12; a signal processing circuit 30; a controller 31; and a plurality of directivity control circuits 21 and 22.

The antennas 11 and 12 are antennas such that an incoming radio wave (an incoming wave) can be received or a signal of the radio communication device 100 can be transmitted, and the directivity of the antennas can be controlled. Individual directivity patterns of respective antennas 11 and 12 are dynamically and independently controlled by corresponding directivity control circuits 21 and 22. A directivity pattern that is selected in the antenna directivity control system 10 can be said to be a selection of a combination of individual directivity patterns for respective antennas 11 and 12. Note that a directivity pattern may be controlled by the antennas 11 and 12, for example, like a case of phased array antennas, without independently controlling the individual directivity patterns of the respective antennas 11 and 12.

Further, each of the antennas 11 and 12 may include a radiating element (an antenna element); and an impedance controller for controlling impedance of the radiating element, so that the directivity can be controlled. The impedance controller is a variable capacitance circuit that can adjust capacitance, or a variable reactance circuit that can adjust reactance, for example. Further, each of the antennas 11 and 12 may be formed of a phased array antenna, so that the directivity can be controlled.

The signal processing circuit 30 is a circuit for processing a received signal that is obtained by receiving an incoming wave by the antennas 11 and 12, or for processing a transmission signal of the radio communication device 100.

The signal processing circuit 30 is a circuit for applying high frequency processing and baseband processing, such as amplification and AD conversion, to a received signal that is obtained by the antennas 11 and 12, for example.

The signal processing circuit 30 includes a measurement unit for measuring received signal quality of a received signal of the antennas 11 and 12, and for measuring channel quality of a received signal of the antennas 11 and 12.

As an example of the received signal quality of a received signal of the antennas 11 and 12, there is a Signal to Interference plus Noise Ratio (SINR). However, the received signal quality of a received signal of the antennas 11 and 12 may be another indicator, depending on a communication method to which the antenna directivity control system 10 can be applied. For example, for a case where it is applied to a Long Term Evolution (LTE) system, there are a Signal to Interference Ratio (SIR), a Received Signal Strength Indicator (RSSI), Reference Signal Received Power (RSRP), Reference Signal Received Quality (RSRQ), and so forth. For a case where it is applied to a Wideband Code Division Multiple Access (W-CDMA) system, there are Received Signal Code Power (RSCP) and so forth.

As examples of the channel quality of a received signal of the antennas 11 and 12, there are Channel State Information (CSI), a rank, and so forth. However, the channel quality of a received signal of the antennas 11 and 12 may be another indicator, depending on a communication method to which the antenna directivity control system 10 can be applied. For example, for a case where it is applied to an LTE system, there are a Channel Quality Indicator (CQI), a Pre-coding Matrix Indicator (PMI), a Rank Indicator (RI), and so forth.

The controller 31 selects a directivity pattern to be set for the antennas 11 and 12 from directivity pattern candidates that are stored in the memory 32 in advance; and outputs, to the directivity control circuits 21 and 22, a control signal corresponding to the selected directivity pattern. The directivity pattern candidates that are stored in the memory 32 in advance are pattern data for achieving different directivity patterns independently for the antennas 11 and 12; and are data of combinations of individual directivity patterns for the respective antennas 11 and 12. The controller 31 may be a microcomputer including a CPU, for example. The memory 32 is a storage device that is provided inside or outside the controller 31.

The controller 31 is an example of a selection unit for selecting, depending on a measured value of the received signal quality and a measured value of the channel quality of a received signal of the antennas 11 and 12, a directivity pattern that is to be set for the antennas 11 and 12 from the directivity pattern candidates that are prepared in advance.

The directivity control circuits 21 and 22 is an example of a setting unit for setting, in accordance with a control signal sent by the controller 31, a directivity pattern that is selected by the controller 31 for the antennas 11 and 12. The directivity control circuits 21 and 22 includes a variable reactance circuit for the antennas 11 and 12, for example.

Thus, a directivity pattern that is to be set for the antennas 11 and 12 is selected from the directivity pattern candidates, depending on the measured value of the received signal quality and the measured value of the channel quality of a received signal of the antennas 11 and 12, so that a proper directivity pattern can be selected by following variations in a radio wave propagation environment. For example, suppose that the measured value of the received signal quality is Msq, and that the measured value of the channel quality is Mcq.

For example, upon detecting that Msq is greater than or equal to a first threshold value and Mcq is greater than or equal to a second threshold value, the controller 31 selects, from the directivity pattern candidates in the memory 32, a directivity pattern such that a correlation coefficient ρₑ between the antennas 11 and 12 is small compared to that of the directivity pattern that is to be selected for a case where Mcq is less than the second threshold value.

For example, upon detecting that Msq is less than the first threshold value and Mcq is less than the second threshold value, the controller 31 selects, from the directivity pattern candidates in the memory 32, a directivity pattern such that the correlation coefficient ρₑ between the antennas 11 and 12 is large compared to that of the directivity pattern that is to be selected for a case where Mcq is greater than or equal to the second threshold value.

For example, upon detecting that Msq is greater than or equal to the first threshold value and Mcq is less than the second threshold value, the controller 31 selects, from the directivity pattern candidates in the memory 32, a directivity pattern such that the correlation coefficient ρₑ between the antennas 11 and 12 is large compared to that of the directivity pattern that is to be selected for a case where Mcq is greater than or equal to the second threshold value.

For example, upon detecting that Msq is less than the first threshold value and Mcq is greater than or equal to the second threshold value, the controller 31 selects, from the directivity pattern candidates in the memory 32, a directivity pattern such that the correlation coefficient ρₑ between the antennas 11 and 12 is small compared to that of the directivity pattern that is to be selected for a case where Mcq is less than the second threshold value, and a combined gain of the antennas 11 and 12 is greater than a predetermined gain value.

<Definition of the Correlation Coefficient ρₑ>

Next, the correlation coefficient ρₑ between the antennas based on the directivity pattern is described. The correlation coefficient ρₑ between the antennas based on the directivity pattern can be derived, for example by Expression 1 (cf. Non-Patent Document 3, for example).

$${ρ}_{e} ≅ \frac{{\vert ∮ \{ {E}_{1} ( θ , φ ) {E}_{2}^{*} ( θ , φ ) P ( θ , φ ) \} \cdot {e}^{- j kx} sin θ d θ d φ \vert}^{2}}{\begin{matrix}∮ \{ {\vert {E}_{1} ( θ , φ ) \vert}^{2} P ( θ , φ ) \} sin θ d θ d φ \cdot \\ ∮ \{ {\vert {E}_{2} ( θ , φ ) \vert}^{2} P ( θ , φ ) \} sin θ d θ d φ\end{matrix}} \qquad [ Expression 1 ]$$

In Expression 1, it is assumed that each of the two antennas with different directivities has sufficiently large cross polarization discrimination (XPD), and that a directivity pattern of a vertical polarization component is predominant. Since the expression that is shown in the original document is so complicated to consider the cross polarization, Expression 1 is simplified by assuming the vertical polarization only.

E₁ and E₂ represent complex electric field directivities, P represents angular distribution of incoming waves, k represents a wave number, and x represents a phase difference between the antennas. θ represents an angle of elevation, and φ represents an angle in a horizontal plane. E₁, E₂, and P are functions of the angles θ and φ.

In the embodiment of the present invention, it is assumed that the angular distribution P(θ, φ) of the incoming waves is “Pt(θ)×Pp(φ),” where Pt(θ) is a normal distribution with respect to the angle of elevation θ, and Pp(φ) is a normal distribution with respect to the angle in the horizontal plane (φ).

An angle that is an average of the angular distribution p(θ, φ) of the incoming waves is referred to as an average arrival angle, and an average arrival angle with respect to the angle of elevation is denoted as mt, and an average arrival angle with respect to the angle in the horizontal plane is denoted as mp. The average arrival angle represents, for radio waves that arrive from multiple directions, for which direction the probability of arriving is large.

An angular range that corresponds to the standard deviation of the angular distribution P(θ, φ) of the incoming waves is referred to as an angle spread, and an angle spread with respect to the angles of elevation is denoted as σt, and an angle spread with respect to the angles in the horizontal plane is denoted as σp. The angle spread represents an extent of concentration of arrival angles of radio waves in the vicinity of the average arrival angle.

Thus, a correlation coefficient for each average arrival angle is calculated by properly changing angles of incoming waves, and an average correlation coefficient that is obtained by averaging these correlation coefficients is adopted as the correlation coefficient in the embodiment of the present invention. The correlation coefficient represents a measure of correlation between antennas.

<Definition of Channel Capacity>

Next, channel capacity is described. The channel capacity represents density of signals that can be multiplexed without interference in a propagation channel in a specific frequency. For a case where the channel capacity is large, communication speed can be increased if different information is transmitted, and a SN ratio can be enhanced if the same information is transmitted.

The channel capacity C is represented by Expression 2 for a case where propagation environment information at a transmission side is known, and optimum transmission power can be allocated.

$$\begin{matrix}C = {\sum }_{i = 1}^{{M}_{0}} {log}_{2} ( 1 + {λ}_{i} {γ}_{i} ) \\ {γ}_{0} = {\sum }_{i = 1}^{{M}_{0}} {γ}_{i}\end{matrix} \} , \qquad [ Expression 2 ]$$

where λᵢ is an i-th eigenvalue of a propagation matrix, and M₀ represents a rank of the propagation matrix. Further, in general, the channel capacity C can often be normalized in terms of a characteristic for a single antenna, and γ₀ represents a SN ratio for a case where reception is executed by a single antenna in a propagation path with pass gain 1.

For a case where γ₀ is sufficiently large, sufficient multiplex gain can be obtained if equal power is allocated to each unique path; and for a case where γ₀ is small, it is expected that a SN ratio can be enhanced by maximum ratio combining if all power is allocated to a path with the largest eigenvalue (cf. Non-Patent Document 4).

γᵢ represents a SN ratio in each unique path. It can be a standard for comparing cases where allocations of power are different to impose a condition such that, between the cases where the allocations of the power are different, total values of γᵢ are equal to each other.

A SN ratio of each unique path during a MIND spatial multiplexing mode is set to γᵢ=γ₀/M₀ (1≦i≦M₀), and a SN ratio for each unique path during a beam forming mode is set to γᵢ=γ₀ (i=1), γᵢ=0 (1<i≦M₀).

In the embodiment of the present invention, an arrival angle of each one of radio waves (an element wave) is generated by a random number, depending on a distribution condition (a distribution condition of arrival angles) of angles of arrival of radio waves (arrival angles), and a propagation matrix is obtained by complex combining the element waves.

Variations of the propagation matrix by fading are obtained by changing initial phases of element waves. The initial phases of the element waves are uniformly distributed. Assuming that a mobile entity including antennas is moving, propagation matrices at fifty locations are calculated.

Furthermore, in the same path environment, average values of received power at the fifty locations are calculated for a case where reception is executed by a single non-directional antenna, and the propagation matrices are normalized. Values of the channel capacity C that are calculated by Expression 2 by using the eigenvalues of the propagation matrices are set to be values of instantaneous channel capacity at the fifty locations. A value that is obtained by averaging the values of the instantaneous channel capacity at the fifty locations (average channel capacity) is set to be an average communication performance indicator in a fading environment.

The antenna directivity control system according to the embodiment is a system for enhancing communication performance by executing control in response to the received signal quality and the channel quality. As a method of expressing variations in the channel quality, namely, variations in the multipath environment, it can be utilized to vary the angle spread of an arrival angle distribution. Thus, an incident angle of an incoming wave with a different angle spread of an arrival angle distribution is properly varied, and the average channel capacity at each average arrival angle is calculated. Then, the maximum channel capacity that is the maximum value among the calculated values of the average channel capacity is adopted as the channel capacity of the embodiment. The channel capacity represents a communication performance indicator between antennas.

<Relationship Between a Directivity Pattern and a Transmission Mode>

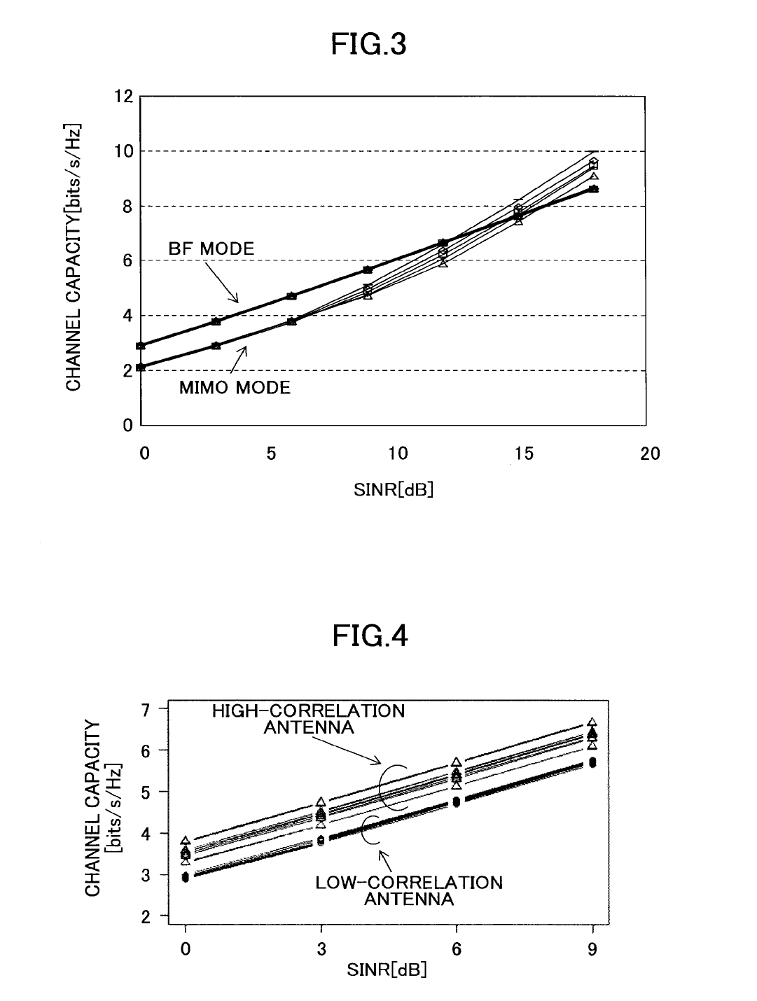

Next, a relationship between a directivity pattern and a transmission mode is explained. FIG. 2 and FIG. 3 are graphs showing comparative data of channel capacity that is obtained for a case of transmitting in the MIMO spatial multiplexing mode (MIMO mode), and for a case of transmitting in the beam forming mode (BF mode), with the same directivity pattern. FIG. 2 is a diagram showing simulation data that shows the relationship between the SINR and the channel capacity for a case where an expected value of the angle spread in the horizontal plane σp is set to 100 degrees. FIG. 3 is a diagram showing simulation data that shows the relationship between the SINR and the channel capacity for a case where the expected value of the angle spread in the horizontal plane σp is set to 10 degrees.

Note that, for incoming waves in FIGS. 2, 3 and 4, assuming that there are many incoming waves that arrive in the horizontal plane, an average arrival angle mt of the angular distribution Pt(θ) of the incoming waves with respect to directions in the angle of elevation is set to 90 degrees (where a direction of zenith is 0 degrees, and a ground plane direction is 180 degrees), and the angle spread at is set to 10 degrees.

Additionally, for selecting a directivity pattern for the examples of FIGS. 2, 3 and 4, assuming an environment that is suitable for the MIMO spatial multiplexing where sufficient multi-paths can be obtained, an expected value of the angle spread σp of the angular distribution Pp(φ) of the incoming waves in the horizontal plane is set to 100 degrees, regardless of the conditions of FIGS. 2, 3 and 4. Then, the average arrival angle mp is varied in 36 ways from 0 degrees to 350 degrees by a 10-degree interval, and the directivity patterns for the examples of FIGS. 2, 3 and 4 are selected by using an average value of correlation coefficients that are calculated for the respective average arrival angles.

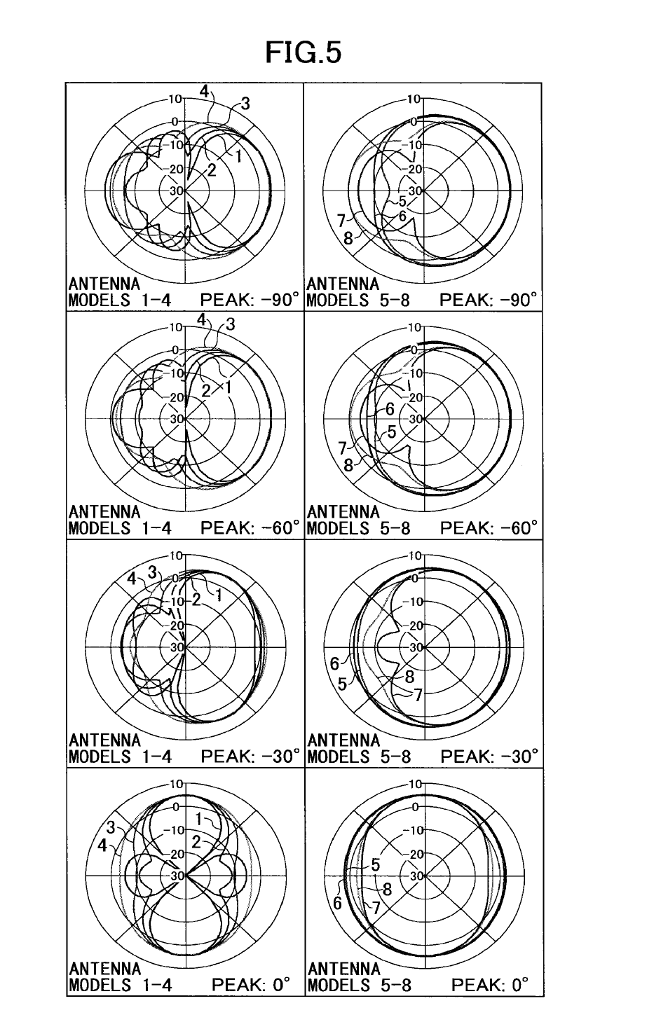

Additionally, for the channel capacity for FIGS. 2, 3 and 4, twelve values of the average channel capacity are calculated by varying the average arrival angle mp in the horizontal plane from 0 degrees to 330 degrees by a 30-degree interval, and the maximum channel capacity, which is the maximum value of these values, is obtained. The expected value of the angle spread σp is 100 degrees for FIG. 2, and is 10 degrees for FIGS. 3 and 4.

A Signal to Interference plus Noise Ratio (SINR) is a ratio of received signal power to interference and noise power in a multi-cell environment where interference of neighboring cells is considered. The SINR is a communication quality indicator that is defined by SINR=S/(I+N). Here, S represents the received signal power, I represents the interference power, and N represents the noise power.

FIGS. 2 and 3 show, for five directivity patterns such that correlation coefficients between antennas are different from each other and the correlation coefficients are small, analyzed data of the channel capacity with respect to the SINR for each of the MIMO mode and the BF mode. Note that this channel capacity is calculated by using Expression 2, while assuming that there is no interference power.

In FIGS. 2 and 3, it is shown that the channel capacity is varied between a case where the transmission mode is the MIMO mode and a case where the transmission mode is the BF mode, even if the combinations of the individual directivity patterns of the antennas 11 and 12 are the same, namely, the directivity patterns are the same. Note that, if the directivity patterns are the same, the correlation coefficients are the same because the correlation coefficient is a property as an antenna.

Thus, according to FIGS. 2 and 3, even if the directivity patterns are the same, the channel capacity for the MIMO mode is greater than the channel capacity for the BF mode under a high-SINR environment, and the channel capacity for the BF mode is greater than the channel capacity for the MIMO mode under a low-SINR environment.

Further, according to FIGS. 2 and 3, under a high-SINR environment, the channel capacity for the MIMO mode for a case where the angle spread σp in the horizontal plane is large is greater than that for a case where the angle spread σp in the horizontal plane is small. Further, according to FIGS. 2 and 3, under a low-SINR environment, the channel capacity for the BF mode for a case where the angle spread up in the horizontal plane is small is greater than that for a case where the angle spread σp in the horizontal plane is large.

Namely, if an environment is a high-SINR environment and an environment where the angle spread σp is large (i.e., an environment where sufficient multi-paths can be obtained), the channel capacity can be increased by transmitting information with a directivity pattern that is suitable for transmission in the MIMO mode. For the MIMO mode, the correlation coefficient between antennas may preferably be small because it is a method of simultaneously transmitting different information with the antennas. Thus, a directivity pattern that is suitable for the transmission in the MIMO mode is a directivity pattern such that the correlation coefficient between the antennas is small. Note that, it may not be true that it is better that the correlation coefficient is as small as possible, and it suffices if the correlation coefficient is smaller than a certain correlation coefficient because, for a case of the MIMO mode, favorable communication can be ensured under an environment where sufficient multi-paths can be obtained.

Whereas, if an environment is a low-SINR environment and an environment where the angle spread σp is small (i.e., an environment where sufficient multi-paths may not be obtained), the channel capacity can be increased by transmitting information with a directivity pattern that is suitable for transmission in the BF mode. For the BF mode, the correlation coefficient between antennas may preferably be large and a maximum value of a combined gain of the antennas may preferably be set to be large because it is a method of simultaneously transmitting same information with the antennas where the directivity is in the maximum gain direction. Thus, a directivity pattern that is suitable for the transmission in the BF mode is a directivity pattern such that the correlation coefficient between the antennas is large and the combined gain of the antennas is large.

For example, FIG. 4 shows simulation data of the channel capacity for transmitting in the BF mode under a low SINR environment for ten sets of pairs of antennas in total, which are five directivity patterns such that correlation coefficients between antennas are different from each other and the correlation coefficients are small, and five directivity patterns having large correlation coefficients. FIG. 4 is a diagram showing simulation data that shows a relationship between the SINR and the channel capacity for a case where an expected value of the angle spread σp in the horizontal plane is set to 10 degrees. As shown in FIG. 4, under the low-SINR environment, the channel capacity for the BF mode with a high correlation coefficient between the antennas is greater than that for a case where the correlation coefficient between the antennas is small.

Further, the angle spread σp in the horizontal plane can be evaluated by a rank. A rank is a value of a Rank Indicator (RI) with which the maximum data rate is achieved in response to the channel condition at the time of measurement, and it represents a number of signal sequences that can be transmitted in parallel. Namely, during a state where the angle spread σp in the horizontal plane is large, the number of signal sequences that can be transmitted in parallel increases, and the rank becomes large. Conversely, during a state where the angle spread σp is small, the number of signal sequences that can be transmitted in parallel decreases, and the rank becomes small.

Note that the rank can be calculated as follows. In the LTE system, channel estimation can be made by using Reference Signals that are transmitted from a base station. From this estimated channel matrix, a correlation matrix is derived, and the rank of this correlation matrix is calculated.

Thus, the controller 31 may preferably select a directivity pattern to be set for the antennas 11 and 12, for example, based on the relationship of Table 1, depending on the measured value of the SINR and the measured value of the rank of a received signal that is obtained by the antennas.

TABLE 1

| | Low SINR | High SINR |
|---|---|---|
| Rank = 1 | Directivity group A | Directivity group C |
| σ ≦ 30 degrees | (high correlation, | (high correlation) |
| | high maximum combined | |
| | gain) | |
| Rank ≧ 2 | Directivity group B | Directivity group D |
| σ > 30 degrees | (low correlation, high | (low correlation) |
| | maximum combined gain | |

Table 1 is a table that shows an example method of selecting a directivity pattern by the controller 31. The SINR and the rank can be measured by the signal processing circuit 30, for example.

The controller 31 selects, upon detecting that the measured value of the SINR is greater than or equal to a predetermined threshold value TH1, and that the measured value of the rank is greater than or equal to 2, a directivity pattern (the directivity group D) for which the correlation between the antennas 11 and 12 is lower than that of the directivity group A or C, for example. If the measured value of the rank is greater than or equal to 2, an actual environment surrounding a mobile entity can be estimated to be an environment where the angle spread σp is greater than 30 degrees (namely, an environment where sufficient multi-paths can be obtained), for example. Thus, by selecting in this manner, a directivity pattern that is suitable for transmission in the MIMO spatial multiplexing mode can be selected in an environment that is a high-SINR environment and that is an environment where the angle spread σp is large (i.e., an environment where sufficient multi-paths can be obtained), and the channel capacity can be increased.

Whereas, upon detecting that the measured value of the SINR is less than a threshold value TH2, and that the measured value of the rank is 1, the controller 31 selects a directivity pattern (the directivity group A) for which the correlation between the antennas 11 and 12 is greater than that of the directivity group D or B, and the maximum value of the combined gain is greater than a predetermined gain value G1, for example. If the measured value of the rank is 1, an actual environment surrounding a mobile entity can be estimated to be an environment where the angle spread σp is less than 30 degrees (i.e., an environment where sufficient multi-paths may not be obtained, and signals are weak). Thus, by selecting in this manner, a directivity pattern that is suitable for transmission in the BF mode can be selected in an environment that is a low-SINR environment and that is an environment where the angle spread σp is small (i.e., an environment where sufficient multi-paths may not be obtained, and signals are weak), and the channel capacity can be increased. The threshold value TH2 may be the same as or different from the threshold value TH1.

Further, upon detecting that the measured value of the SINR is greater than or equal to a predetermined threshold value TH3, and that the measured value of the rank is 1, the controller 31 may select a directivity pattern (the directivity group C) for which the correlation between the antennas 11 and 12 is greater than that of the directivity group D or B, for example. The correlation coefficient between the antennas may preferably be large because a multi-user MIMO mode (Space-Division Multiple Access (SDMA) mode) is a transmission method where multiple terminals use the same frequency at the same time for a single base station. Thus, by selecting in this manner, a directivity pattern that is suitable for transmission in the multi-user MIMO (SDMA) mode can be selected in an environment that is a high-SINR environment and that is an environment where the angle spread σp is small (i.e., an environment where sufficient multi-paths may not be obtained, and signals are strong), and the channel capacity can be increased. The threshold value TH3 may be the same as or different from the threshold value TH1.

Further, upon detecting that the measured value of the SINR is less than a predetermined threshold value TH4, and that the measured value of the rank is greater than or equal to 2, the controller 31 may select a directivity pattern (the directivity group B) for which the correlation between the antennas 11 and 12 is less than that of the directivity group A or C, and the maximum value of the combine gain of the antennas 11 and 12 is greater than a predetermined gain value G2, for example. The correlation coefficient between the antennas may preferably be small and the maximum value of the combined gain of the antennas may preferably be large because a transmit diversity mode is a method where an antenna with high gain is selected from the antennas, or received signals are combined and transmitted. Thus, by selecting in this manner, a directivity pattern that is suitable for transmission in the transmit diversity mode can be selected in an environment that is a low-SINR environment and that is an environment where the angle spread σp is large (i.e., an environment where a certain extent of multi-paths may be obtained, and signals are weak), and the channel capacity can be increased. The threshold value TH4 may be the same as or different from the threshold value TH1. The gain value G2 may be the same as or different from the gain value G1.

<Creation Example 1 of Directivity Pattern Candidates>

The directivity patterns that belong to the directivity groups A, B, C or D, are directivity pattern candidates that are stored in the memory 32, in advance. Next, an example of creating directivity pattern candidates, which are to be stored in the memory 32 in advance, is described.

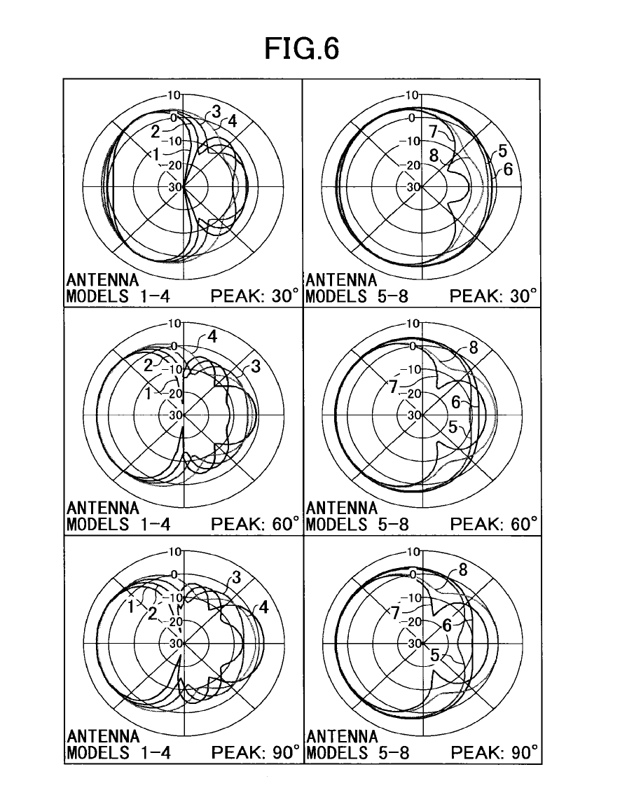

FIG. 5 and FIG. 6 are pattern diagrams showing examples of shapes of directivity model patterns for creating the directivity pattern candidates (in other words, directivity patterns that can be set for the antennas 11 and 12), which are to be stored in the memory 32 in advance. Each of the figures conceptually shows directivity patterns of a specific polarization component in a plane where the antennas 11 and 12 are provided, such as a vertical polarization component in the XY plane.

Pattern data for determining the shapes of the depicted directivity model patterns is data that is created in advance, and in the embodiment of the present invention, array antenna models are used where each of the antennas 11 and 12 is an array antenna. Note that directivity control of each of the antennas 11 and 12 may be by a model according to a directivity control method using a parasitic element; by a method using an impedance control element; or by a model according to a mechanical control method.

Specifically, eight array antenna models, which are array antenna models 1 to 8, are created such that the directivity patterns are different from each other, and 64 pairs of antennas are created by combining two array antenna models from the array antenna models 1 to 8. These two array antenna models correspond to the antenna model of the antenna 11 and the antenna model of the antenna 12. Then, for each of the 64 pairs of antennas, a direction of a main beam of each of the included two antenna models is varied in 7 ways (−90 degrees, −60 degrees, −30 degrees, 0 degree, 30 degrees, 60 degrees, and 90 degrees). In this manner, for each of the 64 pairs of antennas, 28 (=₇₊₁C₂) types of directivity patterns can be created. Thus, 1792 (=64×28) types of directivity model patterns can be created in advance.

Then, among the 1792 types of directivity model patterns, directivity model patterns with which predetermined values of channel capacity (e.g., the top 10 values of the channel capacity) can be obtained may preferably be selected as the directivity pattern candidates, which are to be stored in the memory 32 in advance.

For example, directivity pattern candidates that belong to the directivity group D can be selected from the 1792 types of directivity model patterns in a model environment E_{D} where the transmission mode is set to be the MIMO spatial multiplexing mode, and an expected value of the SINR is set to be greater than or equal to the predetermined threshold value TH1 and an expected value of the rank is set to be greater than or equal to 2. In the model environment E_{D}, directivity model patterns with channel capacity that is greater than or equal to predetermined channel capacity are selected as the directivity pattern candidates that belong to the directivity group D. Note that these can preferably be selected from those with correlation coefficients between the antennas 11 and 12 that are less than a predetermined value because it is efficient.

Further, for example, directivity pattern candidates that belong to the directivity group A is selected from the 1792 types of directivity model patterns in a model environment E_{A} where the transmission mode is set to the BF mode, and the expected value of the SINR is set to be less than the predetermined threshold value TH2 and the expected value of the rank is set to 1. In the model environment E_{A}, directivity model patterns with channel capacity that is greater than or equal to predetermined channel capacity are selected as the directivity pattern candidates that belong to the directivity group A. Note that these can preferably be selected from those with correlation coefficients between the antennas 11 and 12 that are greater than a predetermined value, and with the combined gain of the antennas 11 and 12 that is greater than the predetermined gain value G1 because it is efficient.

Further, for example, directivity pattern candidates that belong to the directivity group C is selected from the 1792 types of directivity model patterns in a model environment E_{c} where the transmission mode is set to the multi-user MIMO mode (SDMA mode), and the expected value of the SINR is set to be greater than or equal to the predetermined threshold value TH3 and the expected value of the rank is set to 1. In the model environment E_{c}, directivity model patterns with channel capacity that is greater than or equal to predetermined channel capacity are selected as the directivity pattern candidates that belong to the directivity group C. Note that these can preferably be selected from those with correlation coefficients between the antennas 11 and 12 that are greater than a predetermined value because it is efficient.

Further, for example, directivity pattern candidates that belong to the directivity group B is selected from the 1792 types of directivity model patterns in a model environment E_{B} where the transmission mode is set to the transmit diversity mode, and the expected value of the SINR is set to be less than the predetermined threshold value TH4 and the expected value of the rank is set to be greater than or equal to 2. In the model environment E_{B}, directivity model patterns with channel capacity that is greater than or equal to predetermined channel capacity are selected as the directivity pattern candidates that belong to the directivity group B. Note that these can preferably be selected from those with correlation coefficients between the antennas 11 and 12 that are less than a predetermined value and with the combined gain of the antennas 11 and 12 that is greater than the predetermined gain value G2 because it is efficient.

TABLE 2

| Directivity | | | | | |
|---|---|---|---|---|---|
| group A | | Pattern A1 | Pattern A2 | Pattern A3 | Pattern A4 |
| 0 | degrees | Pattern | Pattern | Pattern | Pattern |
| | | A1-1 | A2-1 | A3-1 | A4-1 |
| 30 | degrees | Pattern | Pattern | Pattern | Pattern |
| | | A1-2 | A2-2 | A3-2 | A4-2 |
| . . . | | . . . | . . . | . . . | . . . |
| 330 | degrees | Pattern | Pattern | Pattern | Pattern |
| | | A1-12 | A2-12 | A3-12 | A4-12 |

Table 2 is a table that exemplifies directivity pattern candidates that are to be stored in the memory 32 in advance, and that belong to the directivity group A. The shape patterns A1, A2, A3 and A4 are four directivity model patterns that are selected from the 1792 types of directivity model patterns as described above. Further, the angle patterns A1-1, A1-2, . . . A1-12 have respective shape patterns such that their shapes are the same, and only the peak gain directions are different with each other. For example, the shape pattern A1 has twelve angle patterns A1-1, A1-2, . . . , and A1-12 such that the peak gain directions are sequentially different by 30 degrees. Thus, for the case of Table 2, 48 (=12×4) types of directivity patterns are stored in the memory 32 in advance as the directivity pattern candidates that belong to the directivity group A.

Similar to the directivity pattern candidates that belong to the directivity group A, the directivity pattern candidates that belong to the other directivity groups B, C and D, respectively, are stored in the memory 32 in advance.

<Selection and Setting of the Directivity Pattern>

For example, upon the directivity pattern candidates that belong to the directivity group A being selected as the directivity patterns to be set for the antennas 11 and 12, the controller 31 is required to identify an optimum directivity pattern among the selected directivity pattern candidates that belong to the directivity group A. In this case, the controller 31 sequentially sets the selected directivity pattern candidates that belong to the directivity group A for the antennas 11 and 12. The signal processing circuit 30 measures, each time the directivity pattern candidate that belongs to the directivity group A is set, a SINR of a received signal of the antennas 11 and 12. The controller 31 selects, among the selected directivity pattern candidates that belong to the directivity group A, the directivity pattern with the largest measured value of the SINR as the directivity pattern to be set for the antennas 11 and 12. In this manner, the directivity pattern with which the largest channel capacity can be obtained under current environment can be set for the antennas 11 and 12.

The same applies for cases where directivity pattern candidates belonging to the other directivity groups B, C, and D are selected as the directivity patterns to be set for the antennas 11 and 12.

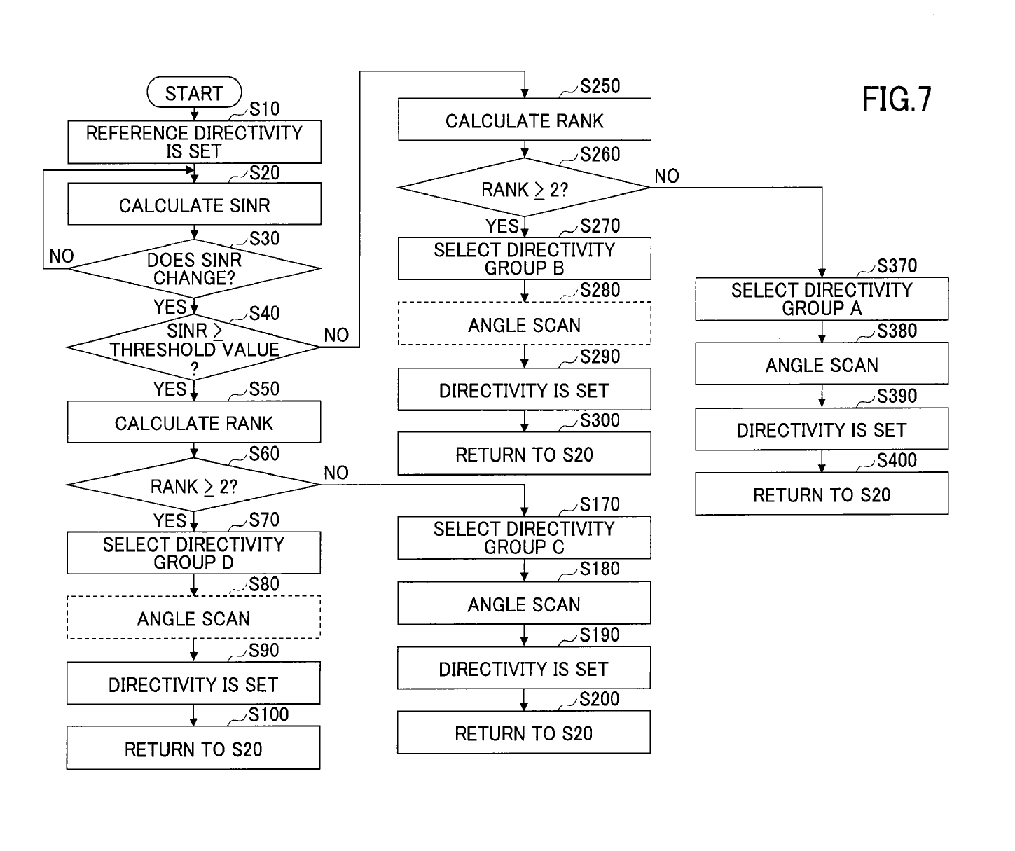

FIG. 7 is a flowchart illustrating an example of a method of selecting a directivity pattern to be executed by the antenna directivity control system 10.

Upon the radio communication device 100 being activated by a power input at step S10, the controller 31 selects a reference directivity pattern that is stored in the memory 32 in advance, and the directivity control circuits 21 and 22 set the selected reference directivity pattern for the antennas 11 and 12.

At step S20, the signal processing circuit 30 measures a SINR of a received signal that is obtained by the antennas 11 and 12, for which the reference directivity pattern is set. Upon detecting, at step S30, that the measured value of the SINR is varied with respect to the measured value for the last time by greater than or equal to a predetermined fluctuation range, step S40 is to be executed; and upon detecting that the measured value of the SINR is not varied with respect to the measured value for the last time by greater than or equal to the predetermined fluctuation range, step S20 is to be executed again.

At step S40, the controller 31 determines whether the measured value of the SINR is greater than or equal to a predetermined threshold value, and upon determining that the measured value of the SINR is greater than or equal to the predetermined threshold value, step S50 is to be executed; and upon determining that the measured value of the SINR is less than the predetermined threshold value, step S250 is to be executed.

In response to detecting that the measured value of the rank that is obtained at step S50 is greater than or equal to 2, the controller 31 selects, as the directivity patterns to be set for the antennas 11 and 12, the directivity group D that is suitable for the MIMO spatial multiplexing mode (step S70). At this time, the controller 31 sequentially sets, among the shape patterns D1, D2, D3, and D4 of the directivity group D that are stored, similar to Table 2, in the memory 32 in advance, angle patterns D1-1 to D4-1 with the peak gain direction of 0 degrees for the antennas 11 and 12, for example; and the controller 31 measures a SINR of a received signal of the antennas 11 and 12, each time one of the angle patterns D1-1 to D4-1 is set. The controller 31 determines, among the angle patterns D1-1 to D4-1 that belong to the selected directivity group D, the shape pattern to which the angle pattern with the largest measured value of the SINR belongs as a temporary directivity pattern to be set for the antennas 11 and 12.

For example, suppose that the temporary directivity pattern that is determined at step S70 is the shape pattern D1. At step S80, the controller 31 executes angle scan where an angle of the shape pattern D1 that is selected at step S70 is varied, and identifies the directivity pattern with which the maximum measured value of the SINR is achieved.

For example, the controller 31 executes angle scan such that angle patterns belonging to the shape pattern D1 (e.g., the twelve angle patterns D1-1 to D1-12 that have the same shapes and only the peak gain directions are different with each other) that are stored, similar to Table 2, in the memory 32 in advance are sequentially set for the antennas 11 and 12. The signal processing circuit 30 measures a SINR of a received signal of the antennas 11 and 12, each time one of the angle patterns D1-1 to D1-12 that belong to the shape pattern D1 is set. The controller 31 identifies, among the angle patterns that belong to the selected shape pattern D1, the angle pattern with the largest measured value of the SINR as the directivity pattern to be set for the antennas 11 and 12.

Note that, for the case of the MIMO spatial multiplexing mode, the angle scan at step S80 may be omitted because the rank is expected to be greater than or equal to 2, with which sufficient multi-paths can be obtained, and the angle spread σp in the horizontal plane is expected to be sufficiently large.

At step 90, the directivity control circuits 21 and 22 set the identified angle pattern for the antennas 11 and 12. In this manner, the directivity pattern with which the largest channel capacity can be obtained under the current environment can be set for the antennas 11 and 12. After step S90, the process returns to step S20 at step S100, and the process of step S20 is to be executed again.

Whereas, upon detecting that the measured value of the rank that is obtained at step S50 is less than 2, the controller 31 selects the directivity group C that is suitable for the multi-user MIMO mode (SDMA mode) as the directivity patterns to be set for the antennas 11 and 12 (step S170). Descriptions of steps S180 to S200 are omitted because they are the same as the processes from step S80 to S100.

Whereas, upon detecting that the measured value of the rank that is obtained at step S250 is greater than or equal to 2, the controller 31 selects the directivity group B that is suitable for the transmit diversity mode as the directivity patterns to be set for the antennas 11 and 12 (step S270). Descriptions of steps S280 to S300 are omitted because they are the same as the processes from step S80 to S100.

Similarly, upon detecting that the measured value of the rank that is obtained at step S250 is less than 2, the controller selects the directivity group A that is suitable for the BF mode as the directivity patterns to be set for the antennas 11 and 12 (step S370). Descriptions of steps S380 to S400 are omitted because they are the same as the processes from step S80 to S100.

<Creation Example 2 of Directivity Pattern Candidates>

The above-described creation example 1 is an example where the directivity pattern candidates are created based on the antenna models on a computer. The creation example 2 is an example where the directivity pattern candidates to be stored in the memory 32 in advance are created based on directivity patterns that are obtained by using antennas that are actually produced, and control circuits that control the directivity of the antennas.

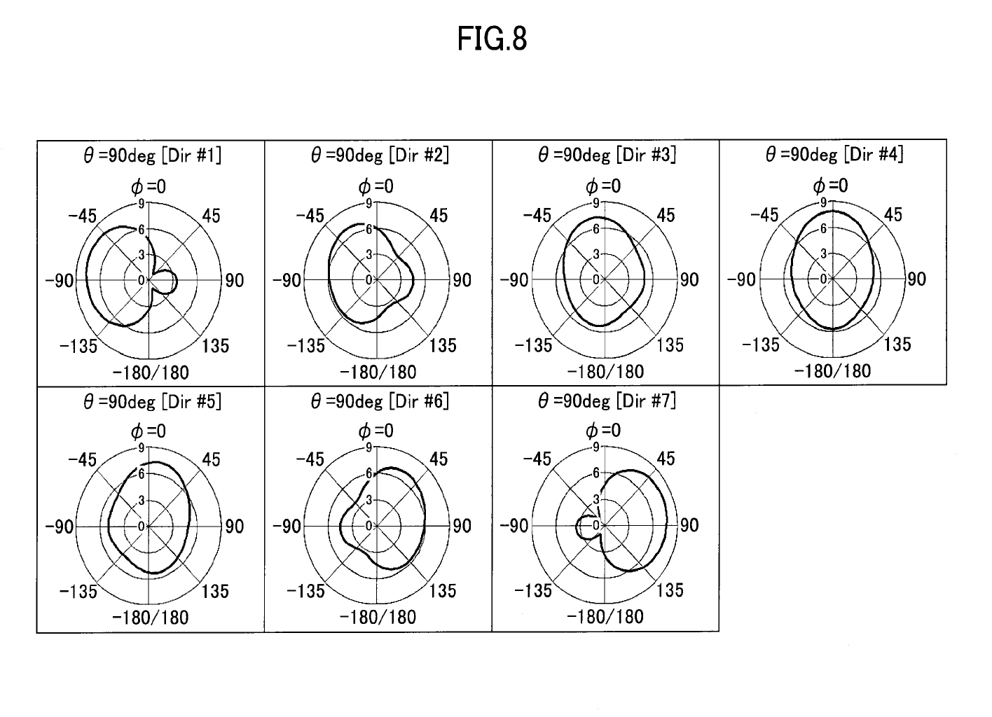

FIG. 8 is a pattern diagram showing examples of shapes of directivity patterns for creating the directivity candidates that are to be stored in the memory 32 in advance. FIG. 8 conceptually shows directivity patterns of a specific polarization component in a plane where the actually produced antennas 11 and 12 are provided, such as a vertical polarization component in the XY plane.

FIG. 8 shows seven types of directivity patterns that are obtained by controlling, by the control circuits, the directivity of the antennas, so that the directions of the main beam are different from each other. The directions of the main beam are seven different directions from −90 degrees to 90 degrees. By individually applying these seven types of directivity patterns to the antennas 11 and 12 that are configured to be the same, 28 (=₇₊₁C₂) types of combined directivity patterns are obtained, which can be generated by controlling the directivities of the antennas 11 and 12.

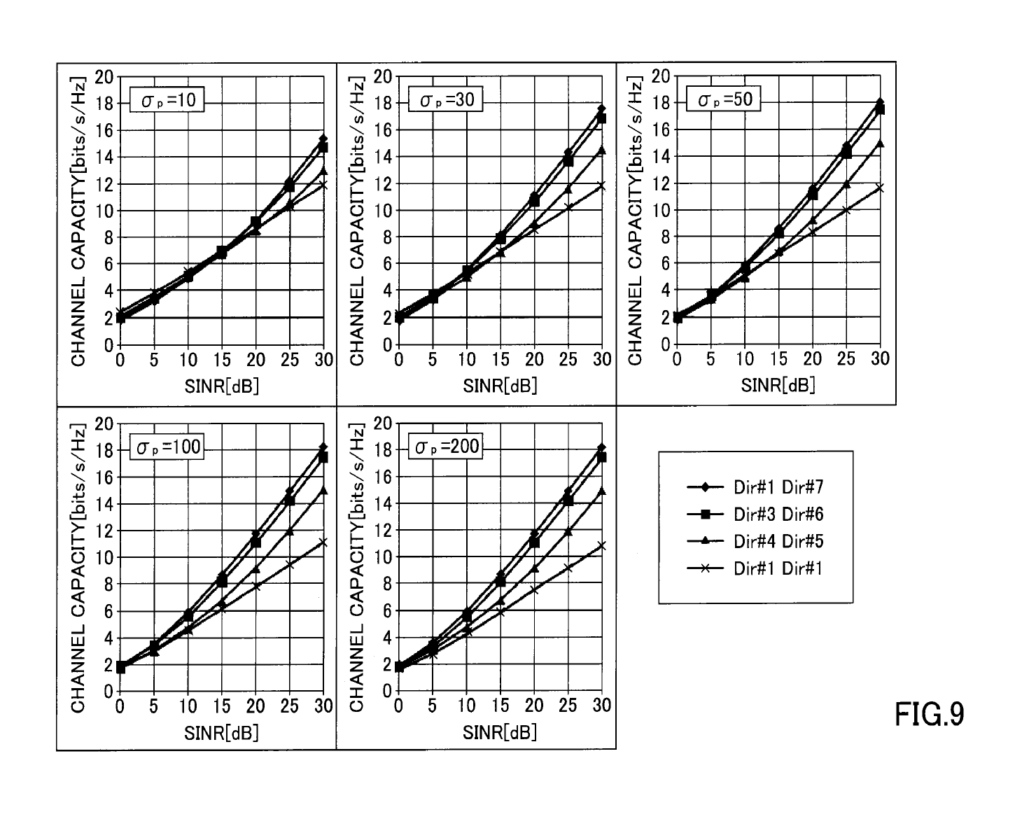

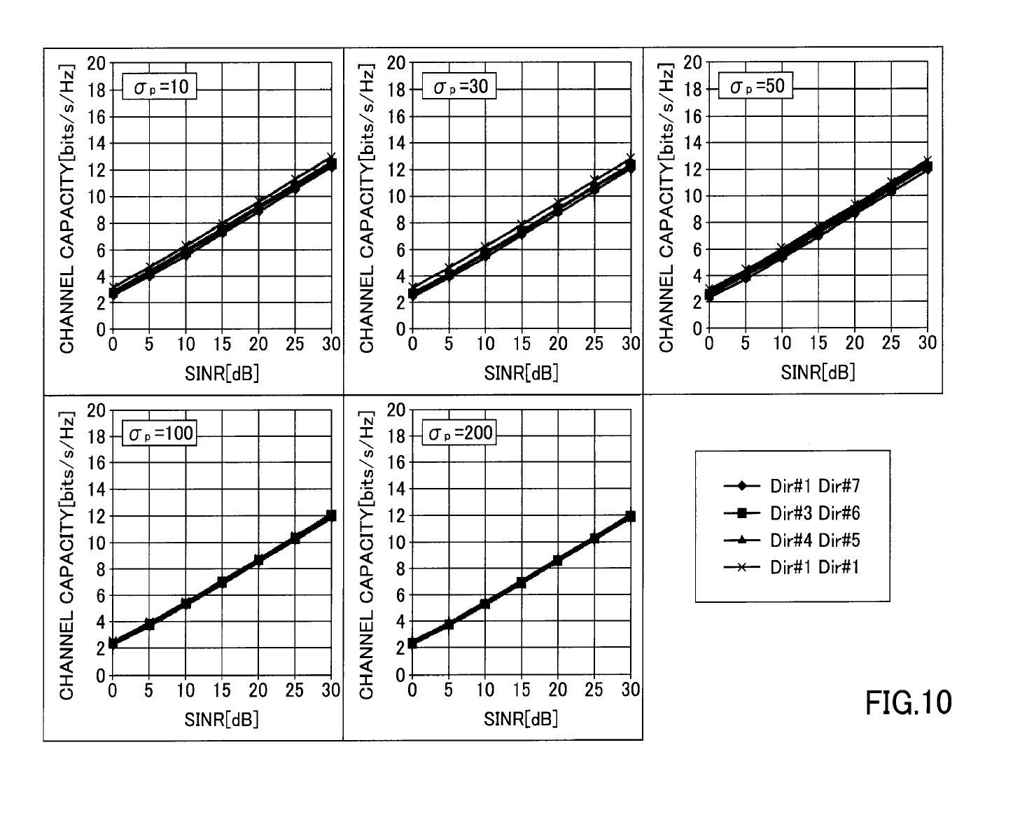

FIG. 9 is a graph set showing an example of analyzed data of the channel capacity with respect to the SINR for a case where transmissions are executed in the MIMO mode for five types of angle spreads σp with four types of directivity patterns for which correlation coefficients between the antennas, which are based on measured data of directivity patterns, are different from each other. FIG. 10 is a graph set showing an example of analyzed data of the channel capacity with respect to the SINR for a case where transmissions are executed in the BF mode for the five types of angle spreads σp with the four types of directivity patterns for which the correlation coefficients between the antennas, which are based on the measured data of the directivity patterns, are different from each other. FIGS. 9 and 10 show five cases where the angle spreads σp in the horizontal plane are 10 degrees, 30 degrees, 50 degrees, 100 degrees, and 200 degrees, respectively.

In FIGS. 9 and 10, “Dir#1 Dir#7” shows analyzed data for a case where the directivity pattern Dir#1 that is shown in FIG. 8 is set for the antenna 11, and the directivity pattern Dir#7 is set for the antenna 12. The meaning is the same for “Dir#3 Dir#6,” “Dir#4 Dir#5,” and “Dir#1 Dir#1.” The correlation coefficient between the antennas 11 and 12 increases in the order of “Dir#1 Dir#7,” “Dir#3 Dir#6,” “Dir#4 Dir#5,” and “Dir#1 Dir#1.”

The correlation coefficients between the antennas 11 and 12 for which these four types of directivity patterns are set are average values of the correlation coefficients that are calculated based on Expression 3 for respective average arrival angles that are obtained by varying the average arrival angle mp in 36 ways from 0 degrees to 350 degrees by a 10-degree interval.

$$\begin{matrix}{ρ}_{e} ≅ \frac{{\vert ∮ \{ \begin{matrix}XPR \cdot {E}_{θ1} ( Ω ) {E}_{θ2}^{*} ( Ω ) {P}_{θ} ( Ω ) + \\ {E}_{φ1} ( Ω ) {E}_{φ2}^{*} ( Ω ) {P}_{φ} ( Ω )\end{matrix} \} \cdot {e}^{- jβ x} d Ω \vert}^{2}}{\begin{matrix}∮ \{ XPR \cdot {E}_{θ1} ( Ω ) {E}_{θ1}^{*} ( Ω ) {P}_{θ} ( Ω ) + \\ {E}_{φ1} ( Ω ) {E}_{φ1}^{*} ( Ω ) {P}_{φ} ( Ω ) \} d Ω \cdot \\ \begin{matrix}∮ \{ XPR \cdot {E}_{θ2} ( Ω ) {E}_{θ2}^{*} ( Ω ) {P}_{θ} ( Ω ) + \\ {E}_{φ2} ( Ω ) {E}_{φ2}^{*} ( Ω ) {P}_{φ} ( Ω ) \} d Ω\end{matrix}\end{matrix}} \\ ∮ d Ω = {\int }_{0}^{2 π} {\int }_{0}^{π} sin θ d θ d φ\end{matrix} \} \qquad [ Expression 3 ]$$

Expression 1 that is described above is a simplified expression where only the vertically polarized waves are considered; however, Expression 3 is an expression where both the vertically polarized waves and the horizontally polarized waves are considered. XRP represents a cross polarization power ratio, and E_{θn}(Ω)E*_{θn}(Ω) and E_{φn}(Ω)E*_{Ωn}(Ω) represent complex electric field directivities of the antennas (n=1, 2). P_{θ}(Ω) and P_{φ}(Ω) represent angular distributions of incoming waves, β represents a wave number, and x represents a phase difference between the antennas. θ represents an angle of elevation, and φ represents an azimuth angle in the horizontal plane. Ω represents a coordinate point (θ, φ) in a spherical coordinate system. For details of Expression 3, reference may be made to Non-Patent Document 3, for example.

Further, the channel capacity in FIGS. 9 and 10 represents the maximum value (the maximum channel capacity) of 36 values of the average channel capacity that are calculated by varying the average arrival angle mp in the horizontal plane from 0 degrees to 350 degrees by a 10-degree interval.

As shown in FIG. 9, for a case of transmitting in the MIMO mode, for the pair of the antennas with a smaller correlation coefficient, the channel capacity can be increased. Then, for an environment with a greater angle spread σp (i.e., an environment where sufficient multi-paths can be obtained), the channel capacity can be increased.

Whereas, as shown in FIG. 10, for a case of transmitting in the BF mode, for the pair of the antennas with a greater correlation coefficient, the channel capacity can be increased. Then, for an environment with a smaller angle spread σp (i.e., an environment where sufficient multi-paths may not be obtained), the channel capacity can be increased.

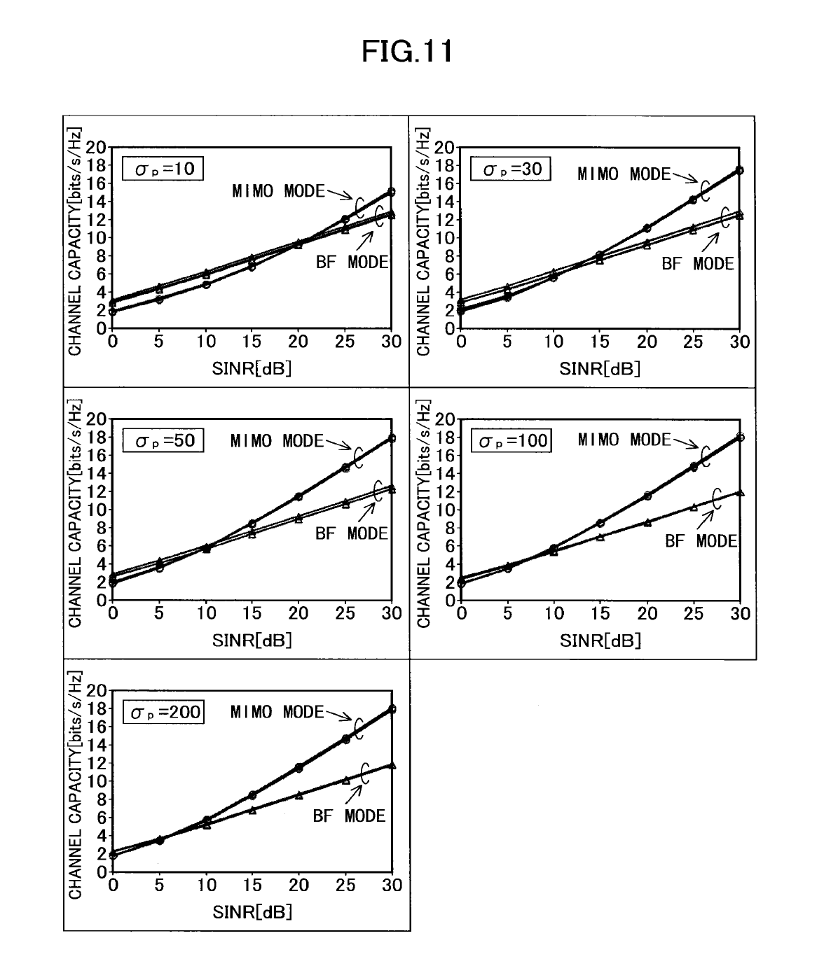

FIG. 11 is a graph set showing an example of analyzed data of the SINR and the channel capacity for cases of transmitting in the MIMO mode and the BF mode. FIG. 11 shows five cases where the angle spreads σp in the horizontal plane are 10 degrees, 30 degrees, 50 degrees, 100 degrees, and 200 degrees, respectively. The analyzed data for the MIMO mode that is shown in FIG. 11 shows cases where transmissions are executed with five types of directivity patterns that are picked up in ascending order of the correlation coefficients, among the 28 types of combined directivity patterns that are obtained in FIG. 8. The analyzed data for the BF mode that is shown in FIG. 11 shows cases where transmissions are executed with five types of directivity patterns that are picked up in descending order of the correlation coefficients, among the 28 types of combined directivity patterns that are obtained in FIG. 8.

For example, the five types of directivity patterns that are picked up in this manner can be stored in the memory 32 as the directivity pattern candidates. Further, as the angle spread σp in the horizontal plane becomes greater, the rank becomes greater.

Thus, according to FIG. 11, for example, upon detecting that the measured value of the SINR is greater than or equal to a predetermined first threshold value th1 and the measured value of the rank is greater than or equal to a predetermined second threshold value th2, the controller 31 can increase the channel capacity by transmitting in the MIMO mode by using one of the above-described five directivity patterns.

Further, for example, upon detecting that the measured value of the SINR is less than the predetermined first threshold value th1 and the measured value of the rank is less than the predetermined second threshold value th2, the controller 31 can increase the channel capacity by transmitting in the BF mode by using one of the above-described five directivity patterns.

The antenna directivity control system is described above by the embodiment. However, the present invention is not limited to the above-described embodiment. Various modifications and improvements, such as incorporating a part of another embodiment or all the other embodiment, or substitution, can be made within the scope of the present invention.

For example, the present invention can be applied for a case where there are three antennas.

Further, the directivity pattern candidates that are exemplified in Table 1 are classified into four directivity groups by setting the single threshold value for determining the magnitude of the measured value of the SINR, and by setting the single threshold value for determining the magnitude of the measured value of the rank. However, the directivity pattern candidates may be classified into more than four groups by setting two or more threshold values for determining the magnitude of the measured value of the SINR, or by setting two or more threshold values for determining the magnitude of the measured value of the rank.

What is claimed is:

1. An antenna directivity control system comprising:
variable directivity antennas;
a measurement unit to measure received signal quality and channel quality of a received signal of the antennas;
a selection unit to select, in response to a measured value of the received signal quality and a measured value of the channel quality, a directivity pattern that is to be set for the antennas from directivity pattern candidates that are prepared in advance; and
a setting unit to set the selected directivity pattern for the antennas.

2. The antenna directivity control system according to claim 1,
wherein, upon detecting that the measured value of the received signal quality is greater than or equal to a first threshold value and the measured value of the channel quality is greater than or equal to a second threshold value, the selection unit selects, from the directivity pattern candidates, a directivity pattern with correlation between the antennas, the correlation being smaller than that of a directivity pattern that is to be selected if the measured value of the channel quality is less than the second threshold value.

3. The antenna directivity control system according to claim 1,
wherein, upon detecting that the measured value of the received signal quality is less than a first threshold value and the measured value of the channel quality is less than a second threshold value, the selection unit selects, from the directivity pattern candidates, a directivity pattern with correlation between the antennas and combined gain of the antennas, the correlation being greater than that of a directivity pattern that is to be selected if the measured value of the channel quality is greater than or equal to the second threshold value, and the combined gain being greater than a predetermined gain value.

4. The antenna directivity control system according to claim 1,
wherein, upon detecting that the measured value of the received signal quality is greater than a first threshold value and the measured value of the channel quality is less than a second threshold value, the selection unit selects, from the directivity pattern candidates, a directivity pattern with correlation between the antennas, the correlation being greater than that of a directivity pattern that is to be selected if the measured value of the channel quality is greater than or equal to the second threshold value.

5. The antenna directivity control system according to claim 1,
wherein, upon detecting that the measured value of the received signal quality is less than a first threshold value and the measured value of the channel quality is greater than or equal to a second threshold value, the selection unit selects, from the directivity pattern candidates, a directivity pattern with correlation between the antennas and combined gain of the antennas, the correlation being smaller than that of a directivity pattern that is to be selected if the measured value of the channel quality is less than or equal to the second threshold value, and the combined gain being greater than a predetermined gain value.

6. The antenna directivity control system according to claim 1,
wherein the selection unit selects, based on measured values of the received signal quality during setting, for the antennas, respective directivity patterns that are selected from the directivity pattern candidates, the directivity pattern that is to be set for the antennas from the selected directivity patterns.

7. The antenna directivity control system according to claim 6,
wherein the directivity pattern that is to be set for the antennas is a directivity pattern with a maximum measured value of the received signal quality, among those of the selected directivity patterns.

8. The antenna directivity control system according to claim 7,
wherein the directivity pattern that is to be set for the antennas is a directivity pattern with a measured value of the received signal quality such that, upon varying angles of the selected directivity patterns, the measured value becomes the maximum measured value.

9. The antenna directivity control system according to claim 1,
wherein the received signal quality is a SINR,
wherein the channel quality is a rank, and
wherein, upon detecting that the measured value of the SINR is greater than or equal to the first threshold value and the measured value of the rank is greater than or equal to 2, the selection unit selects, from the directivity pattern candidates, a directivity pattern with correlation between the antennas, the correlation being smaller than that of a directivity pattern that is to be selected if the measured value of the rank is 1.

10. The antenna directivity control system according to claim 1,
wherein the received signal quality is a SINR,
wherein the channel quality is a rank, and
wherein, upon detecting that the measured value of the SINR is less than the first threshold value and the measured value of the rank is 1, the selection unit selects, from the directivity pattern candidates, a directivity pattern with correlation between the antennas and combined gain of the antennas, the correlation being greater than that of a directivity pattern that is to be selected if the measured value of the rank is greater than or equal to 2, and the combined gain being greater than a predetermined gain value.

11. The antenna directivity control system according to claim 1,
wherein the received signal quality is a SINR,
wherein the channel quality is a rank, and
wherein, upon detecting that the measured value of the SINR is greater than or equal to the first threshold value and the measured value of the rank is 1, the selection unit selects, from the directivity pattern candidates, a directivity pattern with correlation between the antennas, the correlation being greater than that of a directivity pattern that is to be selected if the measured value of the rank is greater than or equal to 2.

12. The antenna directivity control system according to claim 1,
wherein the received signal quality is a SINR,
wherein the channel quality is a rank, and
wherein, upon detecting that the measured value of the SINR is less than the first threshold value and the measured value of the rank is greater than or equal to 2, the selection unit selects, from the directivity pattern candidates, a directivity pattern with correlation between the antennas and combined gain of the antennas, the correlation being smaller than that of a directivity pattern that is to be selected if the measured value of the rank is 1, and the combined gain being greater than a predetermined gain value.
